(19) United States
(12) Patent Application Publication
(10) Pub. No.: US 2007/0104036 A1
(43) Pub. Date: May 10, 2007

(54) Interactive Printed Material and Sensor Apparatus

(75) Inventors: David Lazare Prax, London (GB); Martin Philip Riddiford, London (GB); John Graham Thorne, Cambridge (GB); Paul Antony Honeywell, Northhamptonshire (GB); Andrew John Clift, London (GB); Jeremy Michael Hood, London (GB); Hirand Mamigonians, London (GB)

Correspondence Address: BREINER & BREINER, L.L.C., P.O. BOX 19290, ALEXANDRIA, VA, 22320-0290, US

(73) Assignee: Novus Concepts Limited, Northants (GB)

(21) Appl. No.: 10/565,797

(22) PCT Filed: Jul. 26, 2004
(86) PCT No.: PCT/GB04/03228

§ 371 Date: Jan. 25, 2006

(51) Int. Cl. H04B 1/20

(52) U.S. Cl. 369/1

(57) ABSTRACT

Apparatus having a sensor unit, preferably in the form of a sensor pen, and printed material is described where the two interact in a wide variety of ways. In particular, the printing on the printed material is configured to have different properties, where the difference is not discernible to the naked eye, for example differences in infrared absorption. A variety of arrangements are described, for example for use in early learning activities, and for testing and revision activities using multi-choice question papers. By using good design engineering, the number of different types of reaction from the printed material that the sensor unit can discriminate between may be as many as several tens, or even more than 100.

This invention relates to interactive printed material and sensor apparatus.

Printed material is traditionally used for a wide variety of purposes, including, in particular, educational and amusement purposes. The normal mode of appreciation of printed material is simply by looking at it and analysing the image formed on the retina. The brain then makes sense of what is being looked at and, for example, appreciates whether the image is purely pictorial or, for example, consists of symbols, and, if the latter, it attempts to decipher and comprehend those symbols, be they words or a mathematical expression. By the use of printed material, substantial quantities of information may be distributed widely to the sighted for a myriad of purposes. This information transfer mechanism, however, is limited to the information which can be built into the image and which can be discriminated by the human eye.

In recent decades, it has been appreciated that printed material may carry other information which is not evident to the human eye. Numerous proposals for printing information which requires additional apparatus to discern it have been proposed. Thus, for example, a standard method of protecting items against forgery (or at least to be able to detect forgeries when they occur) is to incorporate in a relevant printed document, for example a currency note, printing which is only revealed, e.g. when the item is illuminated with ultraviolet light. A different approach is to print something which is, although visible, unintelligible, and thus incomprehensible to the viewer. A typical example is a printed bar code: this is perfectly visible as a pattern of black and white stripes, and the size and arrangement of the stripes (and often of accompanying Arabic numerals) enables the human viewer to know that it is a barcode, but the human viewer can do no more than that. However, a bar code reader can extract a signal from the stripes and, using suitable programming, convert the signal, for example into a signal identifying a particular product which bears that bar code.

It can be seen from this that printed material may be configured to provide more information than is evident to the viewer of that material in two different ways: it can contain information which is invisible to the eye, or it can contain information which, while visible, is not comprehensible or intelligible by the human viewer.

In the field of printed material for educational and amusement purposes, these printing techniques have been proposed and, in some cases, have resulted in commercially successful products being placed on the market, in a number of documents forming part of the patent literature. Thus, for example, WO 93/17407, U.S. Pat. No. 6,089,943 and GB-A-2359402 all disclose educational systems consisting of printed matter and some form of barcode reader which is used by the user to interact with the printed matter.

Another approach which has been proposed is to print a so-called “graphical indicator” which is visually negligible, but which can be picked up by an appropriate sensor unit. US-A-2003/0133164 discloses such a system.

One property of printing on a substrate which is not evident to the human eye is that of electrical conductivity. U.S. Pat. No. 3,818,610, U.S. Pat. No. 4,183,152 and U.S. Pat. No. 4,868,374 all disclose educational or amusement devices which rely on the interaction between a “sensor pen” which is held by the user and printed material on an appropriate substrate, normally paper, where the printing is, selectively, in electrically conductive ink. GB-A-2370349, and its equivalent WO 02/50802, disclose a further variant in the form of a question and answer game where the user has a pen including a sensor capable of distinguishing ink fluorescence properties.

Systems which rely on electrically conductive inks and/or on inks containing special fluorescent ingredients are not particularly flexible and, in any event, call for special inks which sometimes in turn require special printing techniques, thus increasing the cost of producing the printed material undesirably.

Published Patent Specification WO-A-83/02842 discloses an interactive printed material/sensor system which makes use of information invisibly printed, but which can be detected by a sensor. In particular, this specification discloses a system of invisibly encoding the printing by exploiting the inability of the human eye to operate at infrared wavelengths. Based on the fact that apparently identical black printing (or four-color process printing) reflects infrared light very differently depending upon the type of “black material” used in the ink, discrimination between visually apparently identical areas can be achieved.

This technique can be used in practice to provide a variety of teaching and amusement systems consisting of a sensor device, usually conveniently configured as a sort of “pen” or “wand” which is held in the hand of the user, and a printed sheet or book. Other configurations of the sensor device, such as a moveable cursor or “mouse” have also been proposed. The sensor device incorporates some form of infrared emitter and infrared sensor, usually at one end if the sensor device is an elongate “pen”, as well as appropriate electronics and a power supply, e.g. in the form of a small battery.

The electronics is usually configured as a single chip to keep down costs and save space, the chip being designed to provide the functions necessary, i.e. sensing the property of the printed material in question (in conjunction with a suitable sensor head, and producing some form of output, usually audible and/or visible, driving e.g. one or more LEDs or an audio transducer. The electronics is usually in the form of an ASIC—an Application Specific Integrated Circuit—connected to the power supply, sensor and output devices. Additionally, the sensor device conventionally includes some sort of switch mechanism, e.g. a ring around the tip of the “pen” which activates the electronics when the tip is placed against a surface. The area of surface to be sensed is printed with printing ink and the electronics in the sensor device then reacts, for example by generating an audible or visual signal dependent upon the infrared absorptive properties of the printed ink. The assembly of ASIC, sensor and power supply can be thought of as a “sensor module” which is incorporated in a suitable casing to form the complete sensor device.

In terms of the printed material with which the sensor device is designed to cooperate, one way of presenting this is in the form of a question and answer sheet where the user is confronted with a question and a set of possible answers, one of which is usually correct and the others of which are wrong. By printing a patch of printing ink of appropriate infrared absorption properties adjacent a printed answer, the user can tell whether the answer is right or wrong by applying the sensor device to the printed patch. The printed patches are often printed in different colors, for example red, green, yellow and blue, so that they appear different and attractive, but where one of them (corresponding to the right answer) contains some carbon black in the black process ink (where, as is very often the case, the patches are printed by four-color process printing). The other patches may contain no carbon black, or a completely different level of carbon black, so enabling the sensor module to discriminate between right and wrong answers.

Variations of the above are easily conceivable. For example, an early learning book may ask the user to identify which fruits illustrated start with a given letter of the alphabet, for example “a”. The accompanying illustration may, for example, show pictorial representations of an apple and an apricot (printed with an ink giving a level of infrared absorption above a given threshold) and pictures of other fruits, such as dates, bananas, oranges, greengages and lemons, all of which are printed with printing ink having a degree of infra-red absorption less than the given threshold. An alternative approach is to provide some form of maze or like multi-track representation, one selected track of which is printed in an ink with infra-red absorption above the threshold, and the other tracks below. If the sensor device is slid along the track, it may indicate, e.g., by the use of a green light-emitting diode, that the sensor device is “on track” while if it is moved off the track, the output may be in the form of a red light indicating that the user has moved off the correct track.

This specification and WO-A-88/05951, which represented a development of the technique described in WO-A-83/02842, achieved some commercial success, but it was found in practice difficult to maintain the quality of printed material and sensor module manufacture so that satisfactory results could be obtained using any sensor pen with any coordinated printed material.

Although WO-A-88/05951 discloses a sensor device provided with a programming mode and a small display screen, the degree of sophistication of activities available with such a device was still relatively limited.

As described in WO-A-83/02842 and WO-A-88/05951, the number of different levels of infrared absorption which can be handled is relatively small, which severely limits the flexibility of operation. Additionally, it is not always as easy as might first appear to render the distinction between infrared absorptive ink patches and infrared reflective ink patches wholly invisible to the naked eye. This problem is identified in U.S. Pat. No. 4,627,819 which suggests a way of overcoming the problem by using printed dot patterns in an attempt to render the distinctions of infrared reflectance wholly undetectable. It is noteworthy that this specification suggests that the inventive techniques described therein can be applied not only in educational and amusement systems involving printed material and a pen or wand as described in WO-A-83/02842, but also applied to so-called “invisible barcodes”.

U.S. Pat. No. 4,627,819 suggests that the scanner may have multiple levels of sensitivity and additionally suggests five different bands of “dot density”, but there is no detail given as to the precise construction and operation of such a scanner, and the degree of sophistication available using the techniques described in U.S. Pat. No. 4,627,819 is still relatively small.

We have now found that it is possible materially to improve the underlying approach identified in these patent specifications and, in particular, to provide improved sensor devices for use with printed material having hidden data therein, in such a way that a very wide variety of educational and amusement activity can be carried out and with substantial user satisfaction.

In accordance with the invention, the basic printed material and sensor device may be enhanced in a variety of ways, and those enhancements may be used either alone or in combination with other enhancements to suit a myriad of potential applications.

The ways in which the underlying technology defined above may be enhanced, in accordance with the invention, include:
configuring the sensor module such as to be able to distinguish between at least five and preferably at least ten different levels of infrared absorption;
configuring the sensor module and the printed material with interactive means enabling self-calibration of the sensor module prior to its being used in conjunction with the printed material or during such use;
providing means for sensing two or more properties of the patch of printed ink and discriminating the response of each such sensing into discrete signals and combining the responses thereby generated to discriminate a plurality of different conditions; for example if the first property is infra-red absorption, the second property may be optical, e.g. color, fluorescence, or non-optical, e.g. conductivity;
providing memory means inside the sensor module capable of maintaining at least transiently a record of successive conditions sensed by the sensor module, and altering the future behavior of the sensor module accordingly;
providing a press switch in the sensor device and means within the sensor module to store and analyses data produced on sequential switch operations and, in response thereto to produce a pre-selected output—visible or audible—and/or to modify the operational mode of the sensor module;
providing the sensor device with an output display in the form of a screen and icons, and wherein the screen and icons include at least one icon recognizably reflective of emotion, and providing within the sensor module software for analysing a series of successive inputs, and adjusting the perceived emotion represented by the screen icon accordingly;
providing the sensor device with an audio output transducer and programming or configuring the sensor module to drive the transducer to produce an audio output selected from a range of possibilities depending upon the properties of an area of printed material against which the sensor device is placed. The range may include recognizable words or phrases or recognizable sounds such as of cheering, sobbing or laughter;
providing in the sensor device means capable of projecting on to an area of the printed material adjacent the area against which a sensor head is pressed a patch of color, for example green for a right answer and red for a wrong one;
providing in the sensor device means capable of illuminating the area on the printed material adjacent an area against which a sensor head is pressed, the printed material being such as to reveal visibly to the human eye, under such illumination, one or more printed features not, or not substantially, visible under normal illumination;
configuring the sensor device in the form of an elongate body having a sensor tip at one end and a screen adjacent or substantially adjacent the other end, the screen being located extending along the side of the elongate body and the sensor module being programmed to display alphanumeric information in accordance with the input received by the sensor, where the direction of the line or lines of alphanumeric information read from left to right runs transversely to the longitudinal axis of the sensor device;
configuring the sensor device as an elongate humanoid or animal figure with a sensor at one end e.g. an infrared light-emitter/detector component, wherein the sensor is covered when the sensor device is not in use by a cover configured to represent footwear of the humanoid or animal figure;
constructing the sensor device as an elongate unit with a sensor located on one end, the end having a removable cap to preserve the sensor from dust, etc., the side of the sensor device having a recess shaped and sized to enable the removable end cap to be press fitted therein, and wherein the removable end cap is captive and may be positioned as desired, press fitted into the recess or covering the sensor;
providing within the sensor module a pre-programmable microprocessor or configurable ASIC or equivalent component and means connected thereto enabling data to be sent from and received by the microprocessor or ASIC via a coded infrared link, and wherein the printed material has associated with it a data storage device which can be interrogated using a coded infrared signal to provide as an output a coded infrared signal which can be decoded by the sensor module and used to program or re-program the microprocessor or configure or reconfigure the ASIC therein.

The features to be selected and/or used individually or in combination from the above list can vary widely depending upon the specific purpose envisaged. In other words, different features may be combined in different ways to provide different interactive sensor device/printed material combinations which are useful in different contexts.

Thus, in accordance with a particular area of the present invention, there can be provided combinations of interactive printed material and sensor device which comprise printed material having information incorporated in printing applied to a substrate which is not comprehensible by the human observer, and wherein the sensor device is adapted to sense a property of the printed material and discriminate between regions of the printing thereof, the sensor device including a display screen and means adapted to display on the screen a set of stylised faces displaying, to the human observer, differing conditions, and wherein the sensor device is configured to resemble an animal or humanoid figure with the screen positioned corresponding to the position of the face thereof, and wherein the sensor device includes a sensor head located at an extremity of the humanoid or animal figure.

Such products are highly attractive to younger children and particularly so if both the get-up of the pen or wand resembles a well-known figure, for example a character merchandise figure, and if the screen and the internal programming are adapted to provide a wide variety of different displays. In particular, the face on the screen may be animated so as to synchronise the lips with a voice output, and the eyes may be made to move randomly or blink, thus providing an illusion that the face is ‘alive’.

At an entirely different level in terms of the target market for interactive printed material/sensor pen combinations, the techniques according to the present invention may be adapted in various combinations to provide substantially more sophisticated teaching or revision materials, or, for example, multiple choice question and answer materials which can be used to carry out a sort of self-administered quiz, either from the point of view of learning and examination of what has been learnt, or from the point of view of entertainment. Accordingly, in another broad aspect, the present invention provides an interactive printed material and sensor device combination comprising printed material having information incorporated in printing applied to a substrate which is not comprehensible by the human observer, and wherein the sensor device is adapted to sense a property of the printed material and discriminate between regions of the printing thereof, and wherein the sensor device is configured to distinguish the regions by measurement of the property of the printed material into at least five categories, and to provide a human appreciable output varying in dependence on the measurement of the property made and/or a sequence of such measurements.

As is generally available and described in the prior art discussed above, a known format for teaching or amusement material is that of printed material and a sensor pen or wand designed to be grasped by the user and brought into contact with the printed material to enable the pen or wand to sense a parameter or property of the portion of the printed material in which it comes into contact, and wherein the actual sensing process is triggered by switch means which are actuated by contact between the printed material and the pen or wand, and wherein the pen or wand contains output means such as a visual display or audible output, the display or audible output being driven in accordance with rules pre-programmed into a sensor module.

In accordance with a broad aspect of the present invention, the programmed nature of the response to be displayed on a visual display or reflected in an audio output alters in response to a combination of the switching of the switch means, the value of the parameter or property sensed by the sensor when actuated following actuation of the switch means, and the timing of the switching of the switch means and the change from one sensed value of the parameter or property to another. Time switching and value of the sensed parameter or property can be considered as three inputs into a complex program stored, for example, in a microchip in the pen or wand, all three being taken into account in real time to determine, in accordance with the programming, the specific output in question, for example whether it is a specific material displayed on a visual display, specific word, music or other audible output emitted by a suitable audio transducer, or a combination of the two. By skillful programming, very sophisticated interactions between printed material and sensor device can be achieved giving the device an aura of “intelligence”. This is particularly the case where the printed material contains pictorial and/or verbal instructions to the user of the system to carry out certain operations with the sensor device. If the user ignores the pictorial or verbal instructions, the sensor device may produce an output indicative of that, for example it may, via an appropriate voice synthesis chip, prompt the user to “Read the instructions again!”, or “No!—follow the track with the end of the pen”.

All of this may be achieved by appropriate programming where the programmed microchip internally of the sensor device can essentially be seen as extracting meaning from the sequential input sequence, and then, working on the basis of that extracted meaning, provide instructions to encourage the user to operate the sensor device itself in an appropriate fashion. Put very simply, a pen or a wand can be programmed to tell you what to do next when you start to use it on a printed page.

In connection with both types of material, both the “activity book” directed at a younger audience and the more serious testing or revision aids, it should be observed that, among the range of individual improvements to the prior art technology described above, the use of a large number of discriminable levels is of major importance. When using a sensor device/printed material combination, if the device can only discriminate a few levels, this may be adequate for “individual operation” on texts—e.g. picking the right answer from a set of four. However, as the intended interaction becomes more of a task, e.g. to sense successive jumbled arabic numerals in the correct order, the need to be able to discriminate more levels becomes much greater—as does the need for self-calibration to ensure consistently even performance.

The printed material or printed matter which constitutes a part of the interactive system of the invention may be produced in a variety of ways, but it is necessary, having regard to the need for the printed material to work sensibly and cooperatively with the sensor module, to exercise due care in terms of the print process used. As is the case in the disclosures mentioned above, the preferred method of printing to produce the printed material is four-color process printing, i.e. material is printed using four so-called process colors and the invisible or unintelligible differences between different parts of the printed material are provided by using different ingredients in the four-color process printing inks used, or, more particularly, using two types of black ink, one containing highly infrared absorptive carbon black, and the other not.

Standard process black ink contains a substantial quantity of carbon black and is highly absorptive to infrared radiation. However, it is possible without difficulty to secure printing inks using other “black” materials, for example incorporating dyestuffs which, while being highly absorptive in the visible spectrum, and which accordingly appear black to the naked eye, nevertheless do not absorb infrared radiation materially. Alternatively, coloured patches may be printed using no process black ink in some cases, and process black ink in others. By adjusting the screen densities of the printing, coloured patches containing no process black ink may look just as dark as those which do.

Using a single sensed parameter, for example infrared absorption, for the printed areas on the printed material can enable the sensor device to discriminate between a number of different conditions, conveniently thought of as different levels of infrared absorption, but even with self-calibration facilities provided on the printed material (explained further below), the number of different levels which can be discriminated is relatively small, for example a maximum of between 5 and 10, and, working towards the top end of this range, it becomes ever more difficult in terms of quality control of the sensor module and process control of the printing to ensure that reliable error-free operation will prevail when the combination is used in practice. There are, however, many instances where the ability to discriminate between more than 10 different conditions is desired, and, in accordance with a particularly preferred feature of the present invention, this may be achieved by arranging that the sensor device looks not just at a single property of the printed material, but at two or even three properties thereof.

This may be achieved by selection of a suitable property for the printing and provision in the sensor module of something which will detect or measure that property. While the present invention is not so limited, a convenient example of this is color.

If, for example, a printed patch printed on relatively white paper or other substrate is printed using process yellow, then if that patch is illuminated with yellow light, the amount of absorption is very small. If, on the other hand, that same yellow light is used to illuminate a patch which contains a process cyan or process magenta, then the materials in those inks absorb yellow light, so the amount of yellow light reflected will be substantially smaller. Analogously, other spectral colors can be detected. If, for example, the sensor device can discriminate between five different colors, and additionally contains means enabling discrimination between six levels of infrared absorption, then the simultaneous testing of a patch of printed material using the sensor device can discriminate between 6×5, i.e. 30 different combinations. Being able to distinguish between 30 different types of printed patch enables, for example, sophisticated or “intelligent” game play using 26 alphabetic letters in a variety of ways.

If the sensor module contains an appropriate microprocessor or ASIC, with suitable pre-programmed material stored in memory, it is possible, for example, to produce a combination of sensor device and printed material with which to play a “spelling game”. In one simple form, the sensor module may be internally programmed to speak (via a voice synthesis chip and transducer) a given word, the object of the game then being to spell that word correctly. By successively applying the sensor device to successive letters chosen from a printed alphabet, in which the combination of properties differs for each letter, the sensor module can detect whether the user has selected the correct letters in the correct order to spell the word it has previously enunciated. If the correct sequence of letters is picked by the user, once that sequence has been detected from successive detections, the sensor device may emit a suitable congratulatory message such as “Well done! Now try spelling . . . ” , the phrase being completed by another word selected at random from a large number stored in the sensor module.

In a relatively straightforward development of the system just described, each time the sensor device is applied to one of the printed alphabetic letters, the audio transducer may emit a spoken “word” corresponding to the letter in question, e.g. “eh”, “bee”, 'sea”, etc.

Numerous variations of this approach can be easily conceived and these may be catered for in a single “book”, for example by providing on successive pages different “games” with a set of printed patches, e.g. at the top of each page which the sensor module can discriminate and which, when sensed successively by the sensor device, can accordingly constitute a programmed “code” which the sensor module recognises and which enables the programmable electronics within the sensor module to operate for a different “game”.

As will be readily appreciated, operating in this way requires the sensor module to have a relatively sophisticated memory storage which will enable a variety of operational modes to be selected. Such sensor modules could be pre-programmed entirely during manufacture, but this is not preferred as it limits the use of the sensor device to use with printed material which operates in accordance with one of the pre-programmed modes. Pre-printed material which operates in accordance with a fresh mode not stored in the sensor module cannot be effectively used. For this reason, it is highly desired to have within the sensor module a re-programmable area of stored data and to carry out re-programming in accordance with the printed material to be used with the sensor device. This can be achieved, for example, by associating with that printed material a simple microchip which contains both stored program instructions and incorporates some sort of output device, for example in the form of an infrared emitter to which a coded data stream may be fed. An infrared sensor forming part of the sensor module can capture that data stream and the electronics internally of the sensor module can then convert it into an appropriate newly programmed operational mode conditioning the behavior of the sensor device to match that required by the particular printed material.

As indicated, above, the present invention is of particular value in the area of learning or revision systems. For example, a revision test paper may be envisaged consisting of a suitable sensor device and printed material showing a printed question in words and a selection of possible answers, against each of which answers a coloured printed patch is positioned. The user indicates his or her choice of answer by pressing the sensor device, e.g. pen configured as a sensor against the printed patch to sense properties of that patch. Dependent upon the result, the sensor device may react in some appropriate fashion, e.g. by giving an indication of whether the answer just identified by pressing is “right or wrong”.

The individual answer patches may in fact be visually discriminable by the normal eye, for example they may be of different colors, but the difference which may be important will not be so visible. However, even in the case where there is one “right” answer, it is highly advantageous to have the user of the sensor device/printed material combination of the present invention provided with more information than merely whether they have got the answer right or wrong.

This can be achieved if desired by ensuring that the sensor module can discriminate between a large number of different states corresponding to the patch of printed material sensed, enabling very effective teaching and/or entertainment material to be produced. Thus, for example, in the simple case of a multi-choice question, not only may the e.g. five different answers be coded as between the correct answer and ones which are incorrect, but, in addition, the incorrect answers may be differentially coded so that the sensor device may be enabled to provide a reaction tailored not merely to the fact that the user has got the answer wrong, but giving more directed and targeted guidance. For example, in the case of a simple mathematical estimation question, there may be a straightforward correct answer, but the others may be close, not so close, or so remote from the question that it is astonishing that they could have been considered for a moment as a potential legitimate answer.

In accordance with the invention, it is possible, in such circumstances, to arrange that the individual visible colors provide, together with the invisible carbon black/non-IR-absorption black balance, a large number of differentiable combinations, so that, e.g., on pressing on a coloured patch, an appropriate voice message may emerge e.g. from a voice synthesis chip and transducer forming part of the sensor device, the particular message being selected from a wide range of stored messages.

There have been many attempts to produce educational devices, for example those sold under the designations LeapPad and Tomy Talking Books, where there is intelligence added to a book and the user has to tell the electronics which page spread is being played with, so the electronics can give the appropriate feedback for that particular page. Usually this is achieved by pressing an appropriate printed start area which is uniquely positioned for each page, and which actuates a circuit in an electronic tablet which underlies the book and which can tell the position of pressure applied by the user with a finger or with a special pen connected to the tablet. However, this needs to be done each time a page is turned, and if not, the printed material will not correspond with the responses, until the user realises and presses the printed start area.

The present invention may be used to produce educational book materials which overcome this problem in two different ways. In one approach, the sensor device is programmed to act generically with all corresponding pages/books. All levels are pre-assigned, and variation from one page to the next is achieved purely in the graphical content of each page, and by using game play techniques which mitigate against apparent repetition. As the user follows instructions on the printed page, hidden coding may cause the sensor device to vary the way it reacts in accordance with its internal programming.

In a more sophisticated approach, the sensor devices are programmed with a game play which requires the responses to be coordinated with each new task. This can be automatically achieved by the sensor device displaying a number or symbol which corresponds with the appropriate printed task/activity. Only when each task is completed is a new number displayed. This new number can be the next sequential task, or a new assignment selected depending on previous performance. In this way, a book of tasks can be different each time the user uses it. The user can be allowed to override the displayed task number if the program allows.

These two approaches, which enable reassignment of the way in which the program operates, constitute important further features of the invention.

As noted above, the sensor module is preferably provided with a method for self-checking and re-calibrating against the particular printed material in question. Thus, it is possible, for example, to identify on the printed material a sequence of differently printed areas or patches and optionally including an unprinted area which may be used by way of calibration materially to enhance the ability of the sensor module to discriminate between different values of a sensed property such as infrared reflectance.

As noted above, the sensor device preferably includes a switch rendering it operative, i.e. triggering a sensing procedure to measure a property. The internal programming of the sensor module may be such as to place it into a sleeping mode if the switch is not actuated for a given length of time, and into a calibration mode on power up so that the first thing a user does when coming to use material produced in accordance with the present invention is to calibrate the sensor device against the particular piece of printed material which is subsequently to be sensed. This is not always ideal, as users tend to ignore such ‘housekeeping’, but, as explained below, recalibration can also occur “on the fly”, i.e. as the sensor device is being used on successive patches of printed material as part of a game or test task.

Self-calibration is important for producing stable sensor device/printed material combinations according to the invention, as the areas of four-color process printing, which react differently when they are looked at by the sensor module, suffer from inevitable variations in print quality, for example variations in ink application rates, screen separations, underlying paper or other stock on which the material is printed. Because of these variables, there is scope for variation in the precise response of any given printed area.

One way of effecting calibration of the sensor module is to identify on the printed material a number of areas, one of which is simply an unprinted area of the base or substrate material and the others of which corresponding in number to the number of different levels of response it is desired to detect. Thus if, for example, it is desired to discriminate on the basis of a single property between six levels of response, the printed material may carry an unprinted area, and five printed areas.

By applying the sensor device sequentially to the blank area and then the five printed areas, the response, for example the infrared reflectance, of the six areas may be determined. The internal processing of subsequently input data corresponding to other areas of the printed material interrogated by the sensor module can then be assessed against the values, e.g. of infrared reflectance or absorption read by the sensor module during the calibration process. Although these will undoubtedly vary slightly, it is easy to arrange internally for the response to be assigned to a particular level provided that it is within a preset tolerance band from that value determined when the test patch was sensed by the sensor module.

For example, if the amount of infrared radiation received by an infrared collector forming part of a sensor pen, on an arbitrary scale, is respectively for the blank and five levels 96, 80, 63, 49, 38 and 21, then the sensor module may be internally programmed to recognise as corresponding to a given one of the five levels responses within the following bands: 78-82, 61-65, 47-53, 38-41, 16-25. It will be noted that these ranges are spaced apart from one another so that there is no overlap. The degree of spacing between such ranges may be chosen appropriately depending upon the amount of sophistication that is built into the sensor module on the one hand and the amount of variability in the printed material emerging from the particular printing process used on the other. The greater the amount of electronic sophistication which is built into the pen, the closer the response bands can be to one another, thus leading to a diminution in the possibility that a sensor parameter will fall within the gap and give rise to an “unrecognised level” when the pen is used. If that does occur, the sensor device may be arranged to prompt the user to “try again”, since variations within a printed area can occur, as can variations in sensing due to, e.g. the precise angle at which the sensor device is held relative to the printed material which is under the control of the user. Very often, re-application of the sensor device will result in a response which can be assigned to one of the levels in question. The device may also be programmed to detect if the number or closeness on time of such “try again” prompts exceeds a certain level and, if it does, prompt the user to re-calibrate the sensor module, e.g. by placing the sensor device successively against a set of printed patches as described above.

As indicated above, it is also possible (and, indeed, preferable) to have the sensor module self-calibrate as the sensor device is used on successive patches. This is of particular importance if the module is arranged to discriminate between several different levels of a given property where the printed patches are intended to have properties precisely corresponding to those seven levels. If the sensor module finds that for a sequence of patches, the detected response is consistently higher than or lower than the target ideal response, then the measurement base line can be shifted internally by the electronics within the sensor module to normalise the measurements to match most closely those theoretically expected.

More generally, self-calibration or recalibration can compensate for a number of variations which can affect the performance of the sensor device. Variations in the printing of the material with which the sensor device is designed to interact are mentioned above, but these are not the only variables. Among others which can be mentioned are the performance characteristics of the sensor head itself. The sensor heads preferably used are semiconductor based packages, and although with modern manufacturing techniques variations can be rendered relatively small, they are inevitable, and being able to compensate for them also enables relatively inexpensive components to be used; the tighter the performance tolerances for semiconductor packaged devices, the greater the cost. Another variable is the distance of the sensor head from the surface of the printed material at the point in time at which sensing takes place. This will depend on the precise geometry of the sensor head and surrounding components. Again, if these need only to be made to reasonable tolerances, the price of the sensor head assembly can be kept low. Finally, even though with modern battery and cell technology, the power supply characteristics may be very little changed depending on the amount of stored electrical energy remaining, as such power supplies run down, there is an inevitable slight change in performance, this only turning into a rapid change as exhaustion of the battery or cell approaches.

Provided that the electronics within the sensor module is programmed appropriately, the device may also detect when the variation is such that a conscious re-calibration, e.g. using a sequence of different patches as indicated above, must be carried out by the user and/or the device may prompt the user, e.g. to replace the battery when recalibration is no longer sufficient to maintain satisfactory operation.

As noted above, the apparatus of the present invention consists essentially of printed material and a sensor device. When the sensor module in the sensor device senses a property of an area of the printed material, it needs to produce (though not always immediately) a perceptible reaction.

In order to produce a perceptible reaction that sensing has actually taken place, the sensor device may be so constructed that each time it is applied to sense the property of an area of printed material, an indication is given that such sensing has taken place. Preferably application of the sensor device to the printed material causes a switch to be actuated, which switch triggers the sensing step, and which may also trigger, e.g. a visual signal such as a flash from a light-emitting diode which is part of the sensor device or an audible signal, e.g. a beep or click. This latter approach is of particular value in connection with apparatus according to the invention configured as a pre-printed test sheet and associated marking sensor. The user may need to work through the entire test paper, e.g. selecting the answer the user thinks is right from a set of possible answers to each question, with the score for the test only being displayed after all of the questions have been answered. In order to feed back to the user the fact that a particular answer has been selected, an audible beep or click can be emitted each time the sensor device is pressed against a printed answer selection area. This feedback can also be achieved by incorporating a ‘click’ switch in the tip which gives a mechanical over-center force feedback as well as a mechanical audible click.

This automatic indication that the sensing has taken place may be thought of as a simple and automatic output provided by the sensor device when in use. The sensor device may, however, contain other output devices, the particular output being dependent on the properties of the area of printing being sensed. Thus, for example, in the case of a simple entertainment or early learning game, for example of the type described in WO-A-83/02842, the output may take the form of an audible output and/or a visual output, for example, as mentioned above, of a face expressing emotion—for example with a downturned mouth if a wrong answer is selected and a smiling mouth if a correct answer is selected. This may be accompanied by audio output, and, if desired, the output may be in the form of speech which is coordinated with changes in the shape of the mouth of a screen display representing a face—such a sensor device will thus appear to talk, and indeed to display a degree of “intelligence”. This is particularly the case if the sensor module is configured to store data from previous sensing activity and then to produce an output dependent not only on the latest area of printed material sensed but additionally on the previous activity of the user.

A third type of output may be considerably more sophisticated and is of substantial value in connection with apparatus according to the present invention for use in multiple choice question and answer tests where, for example, the output by way of a score may be displayed only at the end of the test, for example on some form of display screen built into the sensor device. That display screen may display other information as well, either alphanumerically or by use of appropriate icons.

In this connection, it is of particular value in the case of revision or test papers providing multiple answers from which the user must select the hopefully correct one to provide a numerical indication of which question should be answered next. This prevents the user becoming confused and, in particular, prevents the user answering the same question twice, or missing out an answer.

It should be noted that, in the case of test or revision papers with multiple choice answers, the degree of discrimination required of the sensor device may be relatively small. Indeed, it is sometimes possible to operate perfectly satisfactorily simply with a sensor device discriminating between only two levels of property, but there are substantial advantages in using, say, five levels of property and discriminating between them since this enables, for example, the production of a book of revision or test papers which can be scored by the device itself without necessarily having to be re-programmed before the test or revision exercise is commenced.

For example, if a question and answer paper consists of 20 questions each with multiple possible answers, one of which is correct, the correct answer patch may be printed with a number of different levels, e.g. of infrared reflectance, each of which indicates to the device that the correct answer has been given, but where incorrect answers are either all provided with printing design to give the same level of response, or (preferably) with one of two levels with each question having the patches corresponding to the wrong answers set to one or other of the levels alternately. This can be picked up by the internal logic of a microprocessor within the sensor device and provided that a sequence of several questions is answered correctly, the microprocessor can then decode from the particular sequence the number of questions in the paper and, for example, a target time within which all of the questions should have been answered. This can be done quite easily mathematically by using a non-repeating sequence of four levels, for example of 32 variables in length. If, because the user is inadequately prepared, the sensor device can make no sense of a sequence of detected levels, a message can then be displayed, or, indeed, given audibly that it would be a good idea to go back and do some revision work before attempting the test again.

Because of the complexity of decoding something which is in part invisible anyway, the user is unable to determine with any ease the underlying sequence of coded values embodied in the printed patches and accordingly an appropriately programmed sensor device, when used in conjunction with the revision papers, or book of revision papers, can appear to display substantial intelligence.

As indicated above, on detecting certain input conditions, the sensor device of the present invention may include a further output device in the form of illumination means adapted, on detecting the input, to illuminate an area adjacent the detector head of the sensor device. In a particularly entertaining and intriguing development in accordance with the invention, the printed material contains, printed adjacent a plurality of answer patches, intelligible material which is printed in ink not visible under normal illumination, but which may be rendered visible when illuminated with near ultraviolet light, and wherein the sensor device contains a near ultra-violet-emitting illumination device. In this way, when, e.g. a successful answer is chosen, the illumination device in the sensor device may be triggered and the user looking at the printed material sees, as if by magic, a new inscription emerging. Alternatively, a not very visible marking may be made to stand out strongly if illuminated, e.g. with red or green light.

A further possibility for the output of the sensor device is an audible output, in particular the sensor device constructed to provide a tone generation, which enables the provision of a musical output. In a simple embodiment, individual levels may correspond to individual notes so enabling a tune to be recorded on paper as a series of printed patches and the tune to be reproduced by contacting the sensor device in turn with the printed patches. Alternatively, the tune may take the form of a printed strip with the properties of the strip varying along its length, and the sensor may then be moved along the strip, sensing properties of the printed strip as it goes, and playing a tune corresponding to the printing. This can be particularly entertaining since the speed at which the tune is played can then be varied by the user. The sensor device output may be, in terms of audio output, relatively unsophisticated, e.g. simply producing a musical note of a fairly neutral timbre, or, of course, it may be much more sophisticated, for example emitting a note at a given pitch, but with the timbre corresponding to piano, harpsichord, guitar, trumpet, sousaphone or whatever. In any such sensor device, appropriate means may be provided to select from a number of different “instruments”, for example by arranging for the sensor device to operate first in an instrument selection mode using information encoded in a sequence of patches with sequentially interrogated first, whereafter the device may emit an audible tone (with the timbre of the instrument selected) to show it is ready to play.

It is particularly entertaining, when using the sensor device of the present invention, to arrange that the property measured by the sensor device corresponds to pitch, and such correspondence is essentially continuous. Sliding the sensor device across a pre-printed track may produce a recognizable tune, and applying the sensor device to other areas, for example other substrates such as textiles or painted surfaces, may produce corresponding and entertaining responses.

In terms of the overall configuration of the sensor device, this may vary very widely, but is often most conveniently in the form of some form of elongate body, often referred to “sensor pen” or “wand”, and, for example, as illustrated in the published specifications referred to above. Such an elongate pen may include an appropriate power supply, conventionally one or more batteries fitting into an appropriate compartment, some form of switch, and some form of sensor at one end. For example, that may take the form of an optoelectronic device adapted when actuated to emit a burst of radiation, for example infrared radiation, associated with a radiation detection device adapted to measure the quantity of radiation reflected from the printed material against which the end of the sensor device is placed. As noted above, the end conventionally includes some form of pressure switch to trigger the burst of radiation and the sensing of the amount reflected.

The sensor device will also include some sort of processing electronics.

This may vary from a simple pre-programmed fixed program logic chip to a sophisticated re-programmable microprocessor chip or reconfigurable ASIC. In the second case, reprogramming or reconfiguration can be arranged to be effected by any convenient means, e.g. an input direct electrical connection, and inductive loop connection or a coded infrared input/output unit such as used in “wireless” connection of computer peripherals to a central PC or to unload/download data between e.g. a PC and a PDA. This last is particularly preferred as it enables the sensor device to interact not only with a PDA or PC, but also, for example, with an infrared communication-enabled microchip located e.g. attached to a page of a book or embedded in a card cover thereof. If only a small amount of data is needed for reprogramming or reconfiguration, this may even be provided as a printed strip or strips on the printed material along which the sensor device is scanned to “read” the data and change the behavior of the sensor module.

The use of a programmable microprocessor chip or ASIC also enables the sensor device to take far more notice of the timing of e.g. successive actuation of a proximity switch adapted to trigger a property measurement, and/or the length of time for which such actuation is effected (which may, as it were, tell the sensor device that its sensor head is being moved over a variable property track of printed material).

A further possible input to such a microprocessor might be the angle at which the sensor device is held against the printed material, which can be detected by using an appropriate design of proximity switch adjacent the sensor head.

The various techniques described above for increasing the sophistication of the sensor device lead to the possibility of producing interactive sensor device/printed material combinations which react in a way which is complex, unintelligible to the user, and which provides the possibility of very complex teaching or amusement materials, in particular ones where the mode of interaction between one page or sheet of the material and the sensor device varies from the mode of interaction of a different sheet or page of the same printed material. In one sense, the sensor device appears to be picking up intelligence from the printed page or sheet and using that intelligence to modify its own behavior in a way which is not immediately evident to the user, but which corresponds to the fact that material which is intelligible on each of the printed sheets or pages does mean something to the user because it can be viewed and interpreted. What is viewed and interpreted can be verbal, pictorial, or a combination of the two, and it is the three way interaction between the perceived intelligible material on the printed page, the imperceptible interaction between the sensor device and the printed page and the intelligible interaction between the user and the image which appears on the display which provides for a richness of operation unachievable using the various prior art techniques set out in the specifications referred to above, or at least only achievable with very substantial outlay. Much, of course, depends on the sophistication of the programming, and with the rise in availability of so-called computer games over the last few years, the education and amusement market has become very endured to the sophistication and complexity reflected in current product offerings in that area. The learning or gaming experience obtainable mediated via a computer with a display screen or monitor of standard type and some sort of input/output device such as a keyboard, joystick, mouse, or specially adapted hand-operated unit (such as sold under the Trade Mark PLAYSTATION®) is highly satisfactory, but obviously it requires the use of sophisticated, and accordingly expensive, equipment and, indeed, often fixed equipment, for example a PC in a domestic environment plugged into the normal electrical mains supply. The cost of corresponding recordable devices, i.e. laptop computers, is very substantial, and even the actual cost of smaller hand-held devices, such as palmtop or PDAs programmed with appropriate games software, is substantial. In contrast, by using the techniques described in accordance with the present invention, the cost of the sensor device may be kept down and the cost of printed material, particularly if no special printing ink such as conductible fluorescent inks are needed, is likewise small.

A further degree of sophistication may be built into the devices in accordance with the present invention if the programming in the sensor unit takes into account the sequence of sensed fields and variation over time. What this means is that if results can be obtained by moving the sensor device physically relative to the printed material in different ways. Thus, the sensor device may be contacted and then removed from contact with particular areas of the printed material as a sequence of individual sensings, or, for example, the device may be placed on the material and then slid across the surface thereof,-the signal from the sensor head then varying as the printing underneath the device and viewed by the device changes.

Combined with appropriate programming, this can be used to provide a very wide variety of “special effects” which appear to have a magical quality of “intelligence” about them and this gives rise to a myriad of ways in which entertaining or educational material may be designed.

The present invention is illustrated by way of example with reference to the accompanying drawings which show in schematic form two principal types of sensor device in accordance with the present invention.

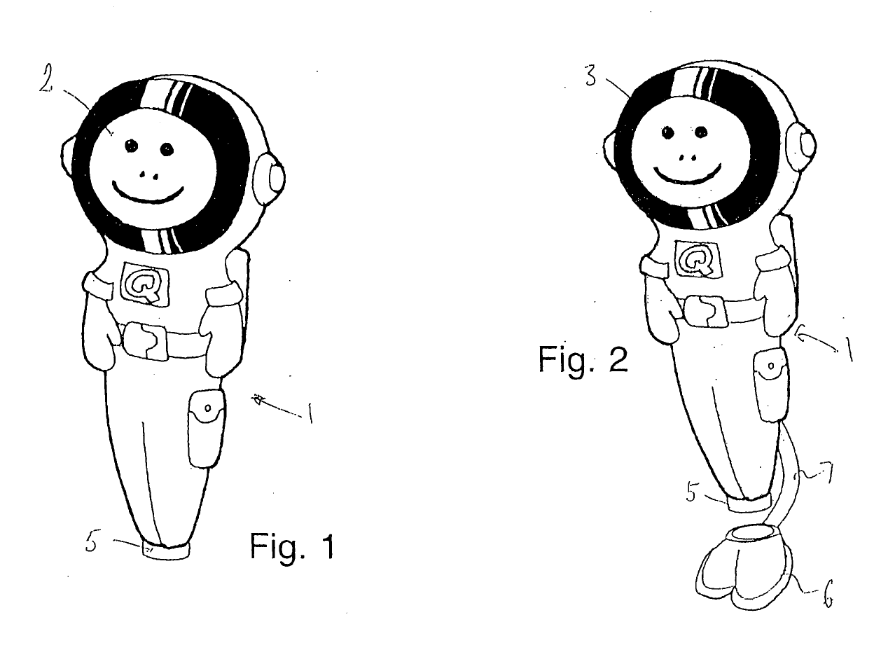

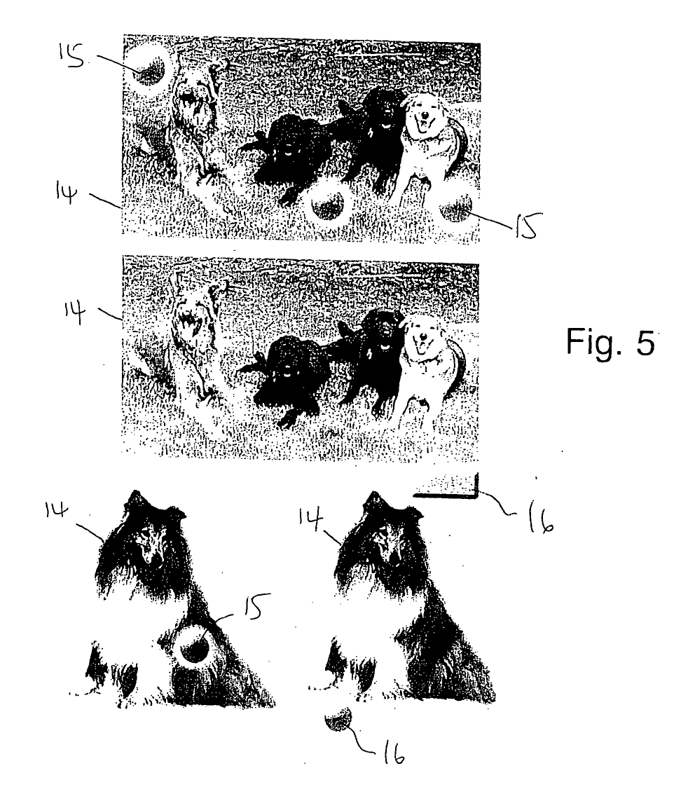

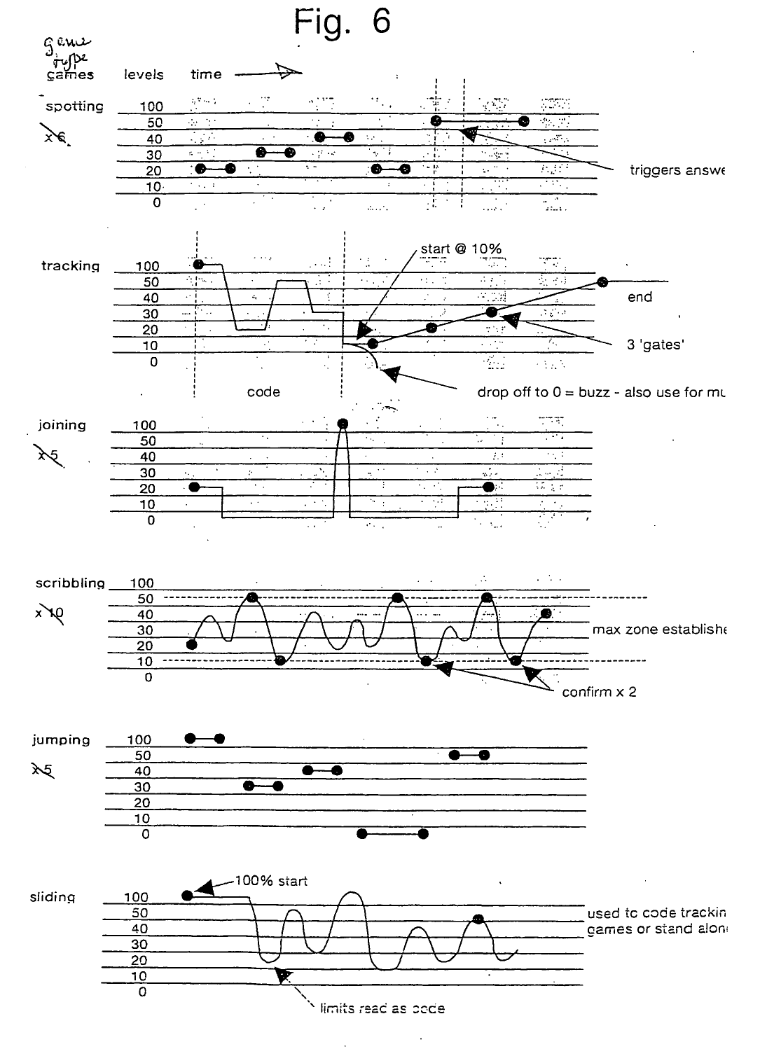

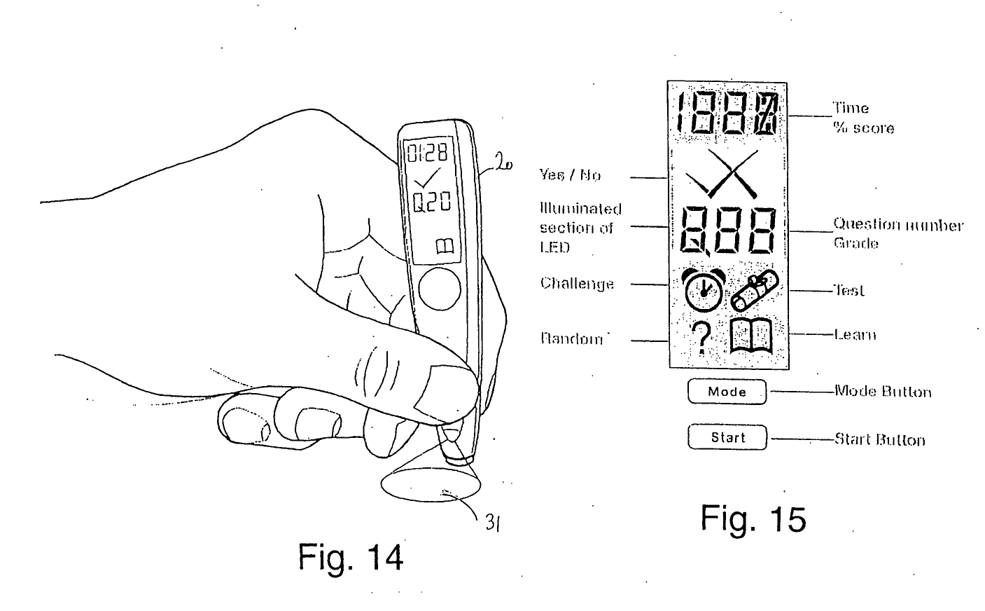

In the drawings, FIGS. 1 to 4 show a sensor device configured for use with a children's activity book, FIG. 5 some ways of presenting illustrations in such a book, FIGS. 6 to 14 a sensor pen useful with a revision aid or test printed material, shown by way of example in FIG. 15, and FIGS. 14 to 17 detailed examples of the construction of the operative end of a sensor pen.

More specifically:

FIG. 1 is a perspective view of a sensor unit for use in accordance with the present invention.

FIG. 2 is a view of the sensor unit of FIG. 1 together with an end cap.

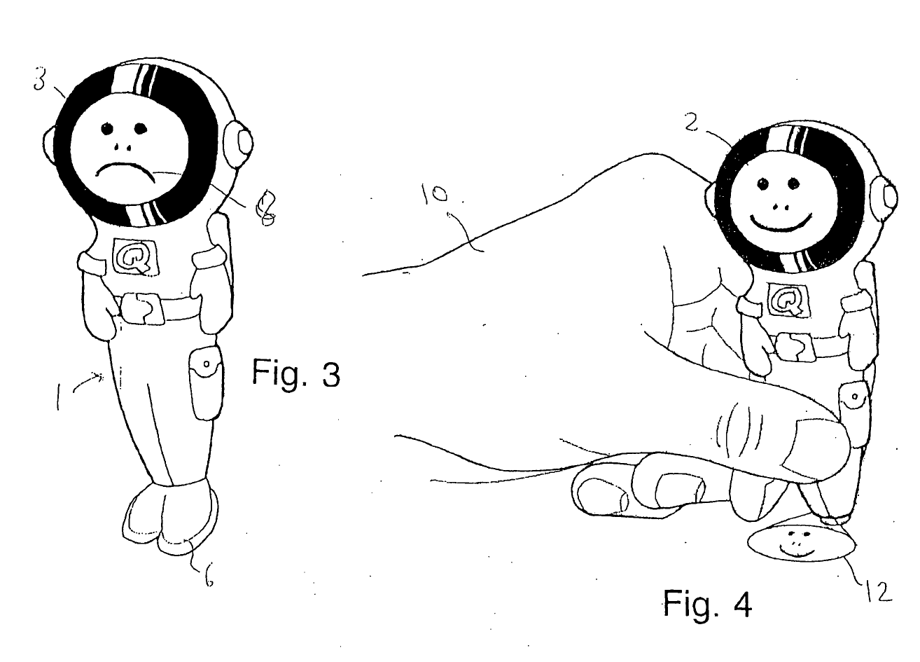

FIG. 3 is a view of the sensor unit of FIG. 1 with the end cap applied.

FIG. 4 is a view showing how the sensor unit of FIG. 1 may be held when being used.

FIG. 5 is a set of illustrations such as might appear printed on the page of an activity book.

FIG. 6 is a diagram illustrating different ways in which the sensor unit of FIGS. 1 to 4 may be used with different printed materials.

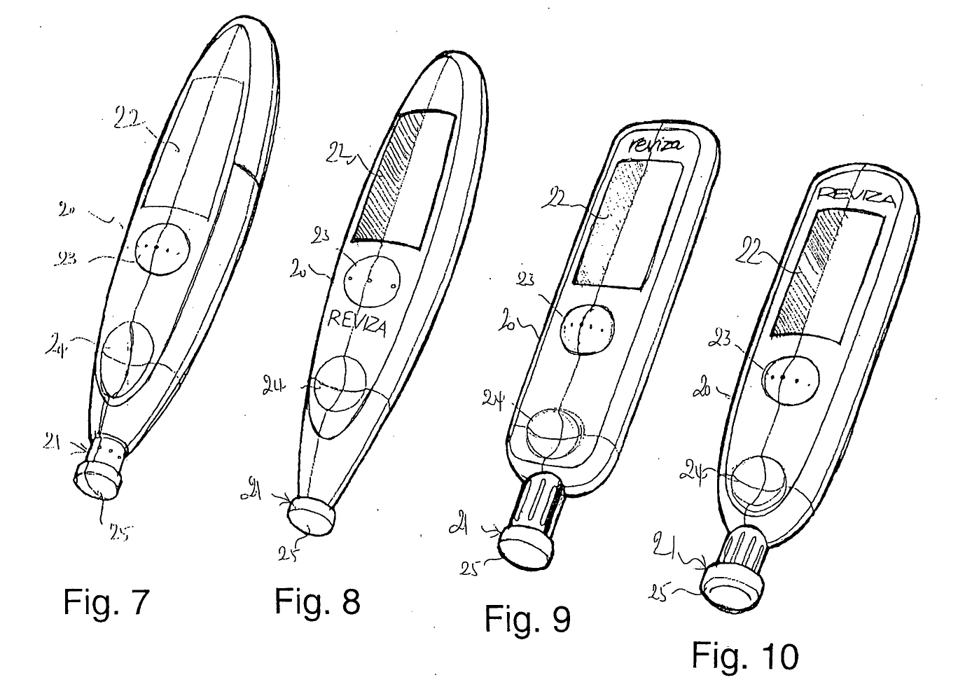

FIGS. 7 to 10 show four variants of an alternative design of sensor unit, for use with a test paper or revision aid.

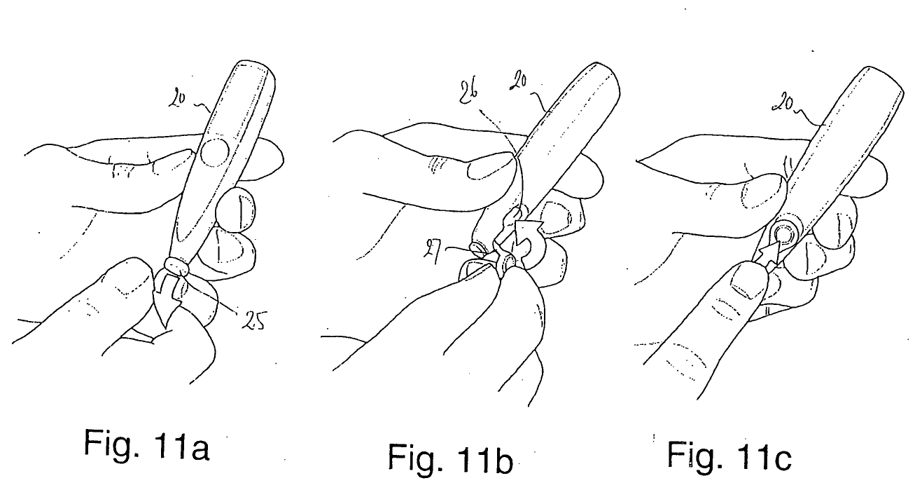

FIG. 11 shows how the end cap of a sensor pen unit may be stowed.

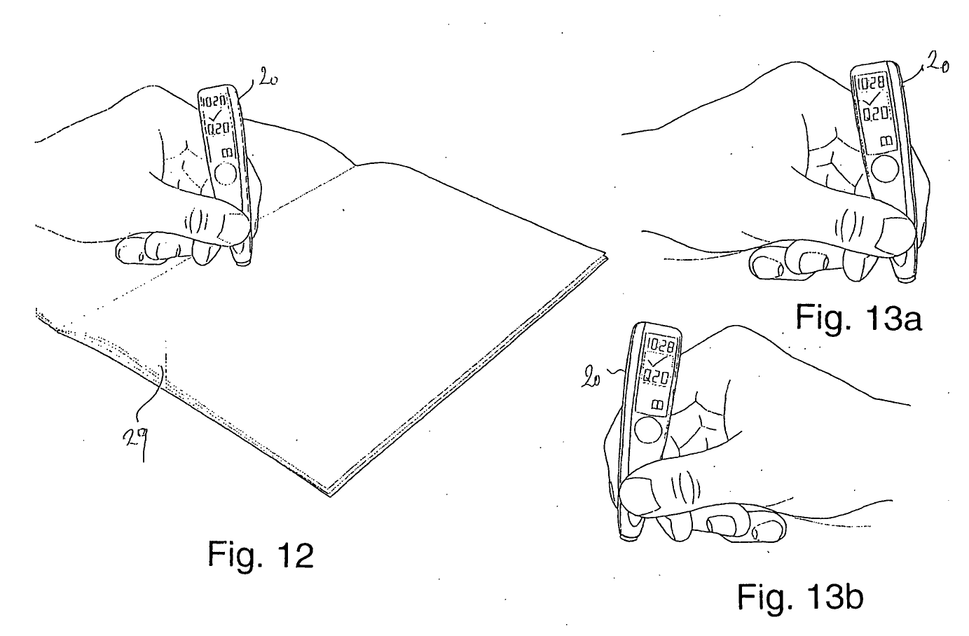

FIG. 12 shows a revision aid sensor pen in use with printed material.

FIG. 13 shows how the pen can be held in either hand.

FIG. 14 shows the pen in use on an enlarged scale.

FIG. 15 is a diagrammatic indication of the type of display that the sensor pen of any of FIGS. 7 to 14 may include.

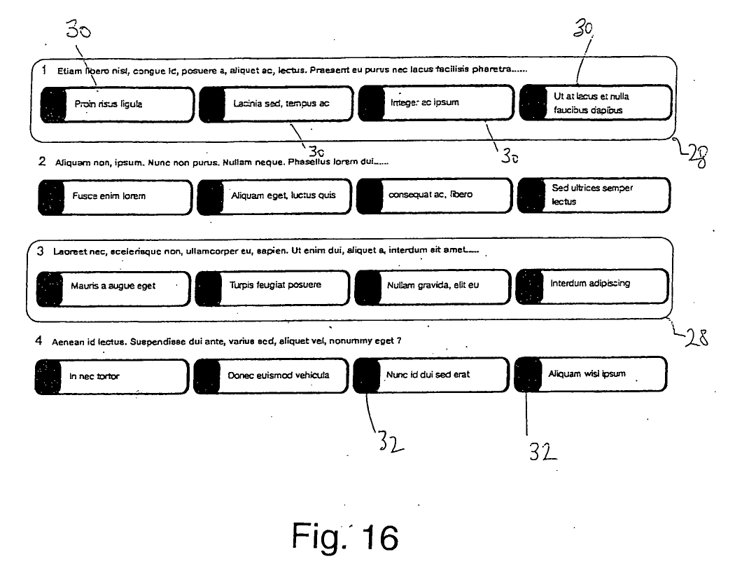

FIG. 16 is a diagrammatic view of the first part of a revision test paper.

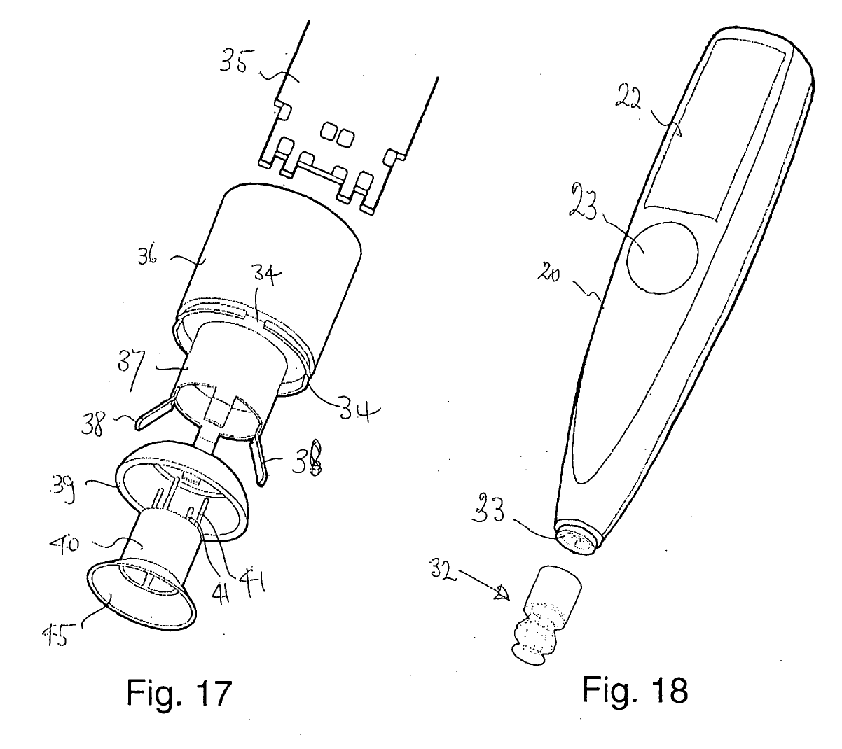

FIG. 17 is a partially exploded view of the sensor pen shown in FIG. 11.

FIG. 18 is an exploded view of the sensor tip construction.

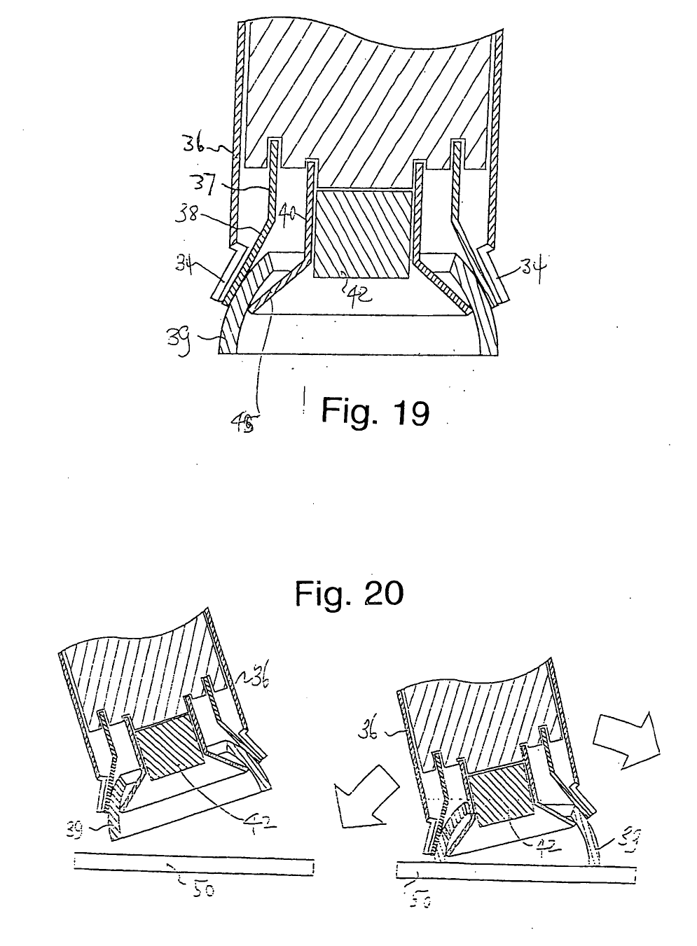

FIG. 19 is a diagrammatic cross-sectional view of the tip construction, and

FIG. 20 shows how that tip construction operates when placed adjacent printed material.

Referring first to FIGS. 1 to 4 of these drawings, it can be seen that the sensor unit there illustrated is configured as a humanoid FIG. 1 dominated by a substantially circular face 2. The face is actually constituted by an LCD screen mounted behind a surrounding bezel 3.

As can be seen in FIG. 1, the face is highly stylised consisting of two eyes, two nostrils and a smiling mouth. At the lower end of the body is a circular ring 5 on to which a cap 6 may be press fitted. Within ring 5 is mounted a suitable sensor, for example a combined infrared-emitting LED and infrared-receiving semiconductor detector. The cap 6 is configured to look like a pair of feet when placed on the body. The cap may be tethered by means of a strap 7 so that it does not get lost.

Internally of the sensor device are mounted appropriate power supplies, an electronics package and other components, the detailed construction of operation of which may vary widely. The electronics may be programmed for example to ensure that when essentially no illumination reaches the sensor within ring 5, i.e. the sensor unit is not being used, then the expression on the face on screen 2 can turn into one indicating disappointment, as, for example, shown in FIG. 3, where specifically that part of the display on screen 2 representing the mouth, identified at 8, is now downturned.

When the device is to be used, the cap 6 is slipped off the end and the detection of incoming light can be arranged very simply to return the display to that shown in FIGS. 1 and 2.

In use, the unit may be grasped by a user's hand 10 as shown in FIG. 4 and the figure then “stood” on top of a printed area, e.g. in a children's activity book.

An enormous variety of interactions may be envisaged depending upon the sensitivity of the sensor unit and the printing of the book. By way of very simple illustration, the book may be a simple multiple answer recognition book, e.g. showing a picture of an animal with four printed names underneath it, only one of which corresponds to the animal depicted. There may be a printed patch by each of the names and the user seeks to identify the correct printed name, i.e. to read it. If the name is correct, the face may continue smiling and, at the same time, as shown in FIG. 4, a smiley face may be projected from a masked LED set into the body of the sensor device on to the surrounding paper. This is shown at 12 in FIG. 4. If a wrong answer is selected, the projected face 12 may not appear and the expression on the screen 2 may change appropriately. By using different printed patches and a sensor device which can discriminate several different reactions from those individual patches, varied and interesting interaction may be provided. For example, in a more sophisticated self-teaching system, there may be a single question with, say, ten answers and corresponding printed patches. Of these, one or possibly two may be correct answers causing the screen display 2 to smile and the image 12 to appear. A next set of the ten answers may be close, which could give rise to a quizzical or puzzled expression on the face on screen 2, further answers may be downright wrong leading to a display as shown in FIG. 3, and, finally, one of the answers may represent a complete “howler” which may give rise to a display on screen 2 showing an open rather than a closed mouth. At the same time, the sensor device may be arranged to emit a suitable noise, or, indeed, if the device contains a speech synthesis chip, some words of congratulation, commiseration or encouragement.

FIG. 5 shows some typical ways in which illustrations can be arranged to appear on the printed page in an activity book for use with the sensor device shown in FIGS. 1 to 4. In this particular example the illustrations are half-tone prints 14—black and white or more usually color—showing dogs. In order to focus attention of the user as to where the device of FIGS. 1 to 4 is to be placed and pressed down to achieve the desired effect, the illustrations incorporate a number of printed “buttons”, which may appear on the illustration itself as shown at 15, or to one side, denoted 16.

FIG. 5 is but one example of a type of activity book page, and very many other types of activity book page can be envisaged. As mentioned above, the activity book page may, for example, be one providing a track along which the pen should be slid to produce appropriate effects, or it may have a sequence, for example of jumbled numbers, which need to be contacted in turn by the end of the sensor unit in order to produce the desired effect.

Another type of illustration which may be incorporated in an activity book may be a hidden pattern, e.g. of alternating levels of absorption in the infrared spectrum, superimposed on an illustration. The user may be able to secure a reaction from that illustration by placing the tip of the sensor unit on it and sliding it to and fro in an oscillating zig-zag or scribbling motion. This can, for example, be used, in an illustrated story book, to produce in an appropriate voice a greeting message from the character illustrated, or, for example, a caricature of the character illustrated on a display screen. A further possibility is a printed illustration sheet with a number of pairs of items illustrated in a left and right hand column to the side of a central dividing line. The instructions may ask the user to place the end of the sensor unit on an item in the left hand column and then, sliding the end of the unit across the page and over the central line, slide it on to its “pair” in the right hand column. This can be done with illustrations or with printed words.

By way of diagrammatic illustration, FIG. 6 shows diagrammatically how the sensor unit may be used over a period of time. The six types of game are identified at the left hand edge of each of the six parts of the illustration forming FIG. 6 and are described as spotting, tracking, joining, scribbling, jumping and sliding types of interaction. The black dots at the end of a line. indicate when the end of the sensor unit is placed on the paper (where the line extending from the dot is to the right, but not to the left, or taken off the paper, where the line extending from the dot goes to the left and not to the right). Thus for spotting and jumping games, the sensor unit is successively brought into contact with the printed page and then removed. Each time the level of the property sensed by the unit is indicated, the diagrammatic illustration 6 showing seven different levels. As can be seen, not all of them are necessarily used in connection with each type of game.

In the case of the pair-picking exercise described above, FIG. 6 illustrates in the third section the “joining” mode of operation where, for example, the infrared absorption of the central line in the middle of the page is designated as level 100 and the diagram illustrates the pen being placed on something in the left hand column with a sensed value of 20, then moved around and across the line in the middle sensed 100 and then back successfully to pick the correct pair which likewise gives a sensed level of 20. A particular advantage of this particular type of game is that it is extremely tolerant of print variations. All that is necessary to operate successfully is to program the pen so that it reacts appropriately, e.g. by displaying a green light or emitting a victory beep or saying “well done” when it encounters a patch of ink having the same value for the sensed property as the patch of ink on to which the pen was originally placed. The absolute value of the property is of no significance and all that is needed is to ensure that the property is different for each of the printed images in one of the columns, the background paper itself and the central dividing line.

Other methods of manipulating the inputs to provide different outputs can be envisaged and the material in FIG. 6 is not intended to be exhaustive.

Turning now to FIGS. 7 to 15, these show varieties of a sensor pen unit configured as a revision aid for students.

FIGS. 7 to 10 show four possible body designs for the pen, each of which consists of an elongate casing 20 provided with a sensor tip 21 at one end and, near the other end, an LCD display screen 22. In addition, the unit has two press buttons 23, 24 arranged one just adjacent screen 22 and the other closer to tip 21. An end cap 25 may be press fitted over the end of the unit and, as shown in FIGS. 10a, b and c, may be easily pulled out of the way of the actual sensor, and twisted round (it is held captive by a tab 27) and lodged in a complementary recess 26 in the side of the casing 20 essentially opposite the screen 22.

Such a pen is shown in use in FIG. 12 with printed material 29 which, for example, may take the form of a revision book, each page of which reproduces a number of questions each accompanied by a number of patches of printed material adjacent possible answers, likewise printed. An example of how the top part of a page in such a book might look is shown in FIG. 16, which shows four questions, numbered 1 to 4. Alternate questions are surrounded by a printed rectangular frame 28. Below each printed question is a set of four cartouches 30, each of which contains a printed possible answer, an has a patch of coloured printing 32 at its left hand end, against which the sensor tip 21 is to be placed. The patches 32 may differ in color, but also differ in e.g. infra-red reflectance, to enable the sensor device to discriminate between the user pressing the sensor tip on a “wrong” answer, and on a “right” one.

As can be seen in FIGS. 13a and 13b, the casing 20 is configured so that the pen can be easily held in the left hand as shown in FIG. 13a or in the right hand as shown in FIG. 13b. In either case, the thumb may be used to operate press button 24, and that press button may itself act as a switch, for example causing the pen then to sense a property of the piece of printed material with which it is at the time engaged. This is useful in a revision situation where, for example, the student has control over the recordal of each answer, i.e. recordal does not take place automatically and possibly inadvertently; rather, recordal of the student answer only takes place when button 24 is depressed by the user's thumb.

As can be seen in FIGS. 12 to 14, the liquid crystal display screen 22 is configured with a number of icons. These are shown more clearly (and as a full set of possibly contrasting areas) in FIG. 15. As can be seen from that Figure, the two buttons 23 and 24 are designated as a mode button and a start button respectively and the first press of the start button (after powering up the device) may serve to start a clock going which will be indicated, for example, in the top line of the display.

The printed page of book 29 may include at the bottom right hand corner, for example, a “test ended” area which causes the sensor pen, when applied to that printed area and button 24 depressed, to display a percentage score on the top line.

The next line of the display as shown in FIG. 15 consists of four areas which can be selectively energised to show a cross if a wrong answer is indicated and a tick if a correct one. This can be, for example, the only part of the display energised if the sensor unit is used in learning mode (apart from the learning mode icon at the bottom right). Thus, in a learning rather than a revision or testing mode, the student can select a possible answer, place the pen over it, press button 24 and immediately learn whether the correct answer has been selected or an incorrect one.

As shown in FIG. 14, the pen may also be provided with a projection device arranged to project a cone of irradiation on to an area identified as 31 in FIG. 14. If the irradiated light is ultraviolet light from a suitable LED and if the illuminated area 31 includes, on-the printed page of book 29, a legend printed in fluorescent (but normally invisible) ink, when the button 24 is pressed, the UV ink fluoresces and the user can see an additional intelligible message.

FIGS. 17 to 20 show details of the construction of the unit and, in particular, that the overall casing 20 has a circular aperture 33 at one end into which a switchable head 32 is fitted. FIG. 17 shows the individual components of head 32 together with one end of a printed circuit board 35 which carries the main electronics used to analyses the results of the sensing and drive the liquid crystal display 22. As shown in FIG. 17, the sensor head 32 consists of an outer metal casing 36, an inner cylindrical metal sleeve 37 having four sprung tags 38 extending from one end thereof, an annulus having a part-spherical surface 39, a mounting tube 40 with a frusto-conically outwardly flared end 45 and an optoelectrical device 42, e.g. a semiconductor emitter/receptor component. Extending from device 42 are four connection leads 41 which, when the item is assembled together, connect to appropriate tracks on printed circuit board 35. The frusto-conical outwardly flared end 45 surrounds the polished emission and reception faces of the device 42 with leads 41, and acts in conjunction with the sprung tabs 38 to hold the part-spherical annulus 39 captive. As can also be seen in FIG. 19, in the position shown, there is no contact between sprung tabs 38 and the lower edge of metallic casing 36, particularly as the tabs 38 are registered with gaps 34 in the lower periphery of casing 36.

When the end of the sensor pen is approached towards the surface of a printed book or test paper, denoted 50 in FIG. 20, the annular part-spherical ring 39 first swivels so as to lie flat against the surface of the printed material 50 even if the sensor pen, as shown in FIG. 20, is not positioned exactly perpendicularly to the surface of the printed material 50. This also acts to shield against stray incoming light, thus assisting the optoelectronic device 42 to sense the properties of the printed image lying thereunder accurately. This is the position shown in the right hand half of FIG. 20. Actual sensing is triggered by pressing the sensor pen down further towards the surface of printed material 50, which causes the sprung tabs 38 to splay apart and allow the lower end of metallic casing 36 to come into contact with ring 39. At the same time, tube 40 moves down and, as ring 39 is held fixed by the paper 50, end 45 ceases to be in contact with ring 39. This making of contact between components 36 and 39 and breaking of contact between components 39 and 45 triggers the electronics mounted on the printed circuit board 35 to energise the optoelectronic device 42 to illuminate the area of printed material 50, e.g. with infrared light, in order to enable the amount of infrared light reflected therefrom/absorbed thereby to be estimated. Such triggering eases as soon as the sensor pen is removed from paper 50.

By operating the mode button 23, a learning mode may be entered by the electronics, for example enabling it to accept complex re-programming via the optoelectronic component 42 which, for this purpose, may, for example, act as the receiving sensor for a coded infrared signal. Various devices for emitting coded infrared signals are known and, in particular, it is possible to use a PC, palm top or laptop which is appropriately equipped with infrared emission technology and an appropriate program as the source of such a stream of coded infrared signals.

It will be apparent from the above specific description and the general description which precedes it that by careful design, a very wide variety of sensor units may be developed in conjunction with a wide variety of printed materials to produce interactive systems in accordance with the present invention. In terms of the printed material itself, this is most preferably produced by four-color process printing and the principal way of differentiating areas non-visibly is to use different levels of infrared absorbing “black” material in the inks used, as set out in the prior art specifications referred to above. However, different printing methods may be used if desired.

As noted above, the parameters detected of the printed material may be more than the simple infrared absorption level as illustrated in the above description with reference to the drawings. For example, by using a more sophisticated optoelectronic head, an estimation of the visible color of a printed patch may be made by the device and that may be used as a discriminating factor as well, either by itself or in combination with a less visible differentiation such as the variable IR absorption “black” component systems.

1. An interactive printed material and sensor device combination comprising printed material having information incorporated in printing applied to a substrate which is not comprehensible by a human observer, and wherein the sensor device is adapted to sense a property of the printed material and discriminate between regions of printing thereof, the sensor device including a display screen and means adapted to display on the screen a set of stylized faces displaying, to the human observer, differing conditions, and wherein the sensor device is configured to resemble an animal or humanoid figure with the screen positioned corresponding to a position of a face thereof, and wherein the sensor device includes a sensor head located at an extremity of the humanoid or animal figure.

2. A combination according to claim 1, wherein the printing on the substrate contains information discernible by an amount of infrared absorptive material in ink used to effect said printing.

3. A combination according to claim 1 or 2 wherein the means to display fur displaying a stylized face is configured to display screen areas representative of eyes, nose and mouth, the areas representative of at least eyes and mouth being capable of displaying different stylization thereof in different combinations to reflect different emotions.

4. A combination according to claim 1, wherein the sensor device has a casing configured as a stylized humanoid or animal elongate figure, and wherein the casing includes a sensor module with the sensor head located adjacent one end thereof.

5. A combination according to claim 4 wherein, adjacent the sensor head, is a pressure-operated switch adapted to trigger sensing of the property of the printed material when the figure is stood on a surface thereof and in a region of printed material under an end adjacent the sensor head.

6. A combination according to claim 1 further comprising a sound-generating circuit and a sound transducer.

7. A combination according to claim 6 wherein the circuit is adapted to provide an intelligible speech output.

8. A combination according to claim 7 wherein the sensor device includes means to vary at least representation of a mouth on the screen corresponding to and synchronized with the speech output.

9. A combination according to claim 1 further comprising within the sensor device means for illuminating an area of the printed material adjacent a position at which the sensor device is pressed against the printed material.

10. A combination according to claim 9 wherein the means for illuminating are actuated in response to a particular value of a property of the printed material sensed by the sensor device and in accordance with conditions preset internally of the sensor device.

11. A combination according to claim 1 further comprising within the sensor device means for sensing a value of at least two properties of an area of the printed material against which the sensor device is pressed.

12. A combination according to claim 11 wherein the sensor device includes a sensor module adapted to produce an output varying in response to a combination of two or more properties of the printed material sensed.

13. A combination according to claim 11 or 12 wherein the two or more properties sensed are infra-red absorption of the printed material and color thereof.

14. A combination according to claim 1, wherein the sensor device includes means within a sensor module incorporating a microprocessor or ASIC adapted to store data relating to a sequence of sensing operations carried out on the printed material and to produce an output dependent on such data as well as on at least one property of the printed material being sensed.

15. An interactive printed material and sensor device combination comprising printed material having information incorporated in printing applied to a substrate which is not comprehensible by a human observer, and wherein the sensor device is adapted to sense a property of the printed material and discriminate between regions of printing thereof, and wherein the sensor device is configured to distinguish the regions by measurement of the property of the printed material into at least five categories, and to provide a human appreciable output varying in dependence on the measurement of the property made and/or a sequence of such measurements.

16. A combination according to claim 15 wherein the printed material is configured as a multiple option question/answer paper, with a set of readable questions, each of which has, printed in spaced coordinated positions relative thereto, a set of answers, and wherein the printed answers each include an area of printing in a printing ink, a property of which may be sensed by the sensor device.

17. A combination according to claim 15 or 16 wherein the printed material comprises a set of five or more printed areas differentially printed corresponding to the at least five categories into which the property of an area measured by the sensor device may be allocated, and the sensor device includes means for adjusting the measurement of the property in question following carrying out a sequence of measurements on a set of printed areas.

18. A combination according to claim 15, wherein the sensor device is in a form of an elongate casing incorporating a sensor head located at one end thereof and a display screen at or near another end, the screen located so as to be viewed in a detection substantially transverse to a direction of elongation of the casing.

19. A combination according to claim 18 wherein associated with the sensor head is a pressure switch adapted to trigger sensing of the property of the printed material when one end of the casing is applied to the surface of the substrate.

20. A combination according to claim 15, wherein the sensor device is adapted to sense two or more different properties of the printed material and by measurements of those properties to allocate the area into one of a plurality of categories based on a combination of the measurements of the two or more different properties.

21. A combination according to claim 15, wherein human appreciable output takes a form of intelligible information displayed on a screen forming part of the sensor device.

22. A combination according to claim 21 wherein the information is displayed following each measurement of a property effected by the sensor device.

23. A combination according to claim 21 wherein the information is displayed only after measurement of a property of a sequence of areas successively brought into proximity with a part of the sensor device by a user thereof, the information displayed being derived from results of the sequence of measurements.

24. A combination according to claim 23 wherein the information displayed depends additionally on overall time taken to complete the sequence.

25. A combination according to claim 15, wherein the sensor device contains memory means enabling a sequence of measurements to be stored and logic means enabling a sense-perceptible output to be generated in consequence of a logical analysis of the sequence of measurements.

26. A combination according to claim 1 or 15, wherein the sensor device is capable of discriminating between at least 5 levels of a property of the printed material.

27. A combination according to claim 26 wherein the sensor device can discriminate between at least ten levels of the property of the printed material or at least 20 combinations of two properties of the printed material.

28. A combination according to claim 26, wherein the sensor device is adapted to effect calibration or re-calibration to assist in discrimination between the levels or combinations of properties.

29. A combination according to claim 1 or 15, wherein the sensor device includes a sensor module which can be programmed or reprogrammed with data stored in a chip or other device forming part of or attached to the printed material.

30. A combination according to claim 29 wherein the sensor module includes means for decoding a coded stream of infrared radiation corresponding to the stored data.

31. Interactive printed material and sensor apparatus comprising one or more sheets of printed material having a plurality of patches of printed ink thereon, and a sensor device including a sensor module capsule of discriminating property of the patches of printed ink, and output means capable of producing an audible or visible output in dependence on interaction between a patch and the sensor module having at least one of:
configuring the sensor module such as to be able to distinguish between at least five different levels of infrared absorption;
configuring the sensor module and the printed material with interactive means enabling self-calibration of the sensor module prior to its being used in conjunction with the printed material or during such use;
providing means for sensing two or more properties of the patch of printed ink and discriminating response of each such sensing into discrete signals and combining the responses thereby generated to discriminate a plurality of different conditions;
providing memory means inside the sensor module capable of maintaining at least transiently a record of successive conditions sensed by the sensor module, and altering future behavior of the sensor module accordingly;
providing a press switch in the sensor device and means within the sensor module to store and analyze data produced on sequential switch operations and, in response thereto to produce a pre-selected visible or audible output and/or to modify an operational mode of the sensor module;
providing the sensor device with an output display in a form of a screen and icons, and wherein the screen and icons include at least one icon recognizably reflective of emotion, and providing within the sensor module software for analyzing a series of successive inputs, and adjusting a perceived emotion represented by a screen icon accordingly;
providing the sensor device with an audio output transducer and programming or configuring the sensor module to drive the transducer to produce an audio output selected from a range of possibilities depending upon properties of an area of printed material against which the sensor device is placed.
providing in the sensor device means capable of projecting on to an area of the printed material adjacent an area against which a sensor head is pressed a patch of color;
providing in the sensor device means capable of illuminating an area on the printed material adjacent an area against which a sensor head is pressed, the printed material being such as to reveal visibly to a human eye, under such illumination, one or more printed features not, or not substantially, visible under normal illumination;
configuring the sensor device in a form of an elongate body having a sensor tip at one end and a screen adjacent or substantially adjacent another end, the screen being located extending along a side of the elongate body and the sensor module being programmed to display alphanumeric information in accordance with input received by the sensor device, where direction of a line or lines of alphanumeric information read from left to right runs transversely to a longitudinal axis of the sensor device;
configuring the sensor device as an elongate humanoid or animal figure with a sensor at one end, wherein the sensor is covered when the sensor device is not in use by a cover configured to represent footwear of the humanoid or animal figure;
constructing the sensor device as an elongate unit with a sensor located on one end, the one end having a removable cap to protect the sensor, a side of the sensor device having a recess shaped and sized to enable the cap to be press fitted therein, and wherein the removable end cap is captive and may be positioned as desired, press fitted into the recess or covering the sensor;
providing within the sensor module a pre-programmable microprocessor or configurable ASIC or equivalent component and means connected thereto enabling data to be sent from and received by the microprocessor or ASIC via a coded infrared link, and wherein the printed material has associated therewith a data storage device which can be interrogated using a coded infrared signal to provide as an output a coded infrared signal which can be decoded by the sensor module and used to program or re-program the microprocessor or configure or reconfigure the ASIC therein.

32. Teaching or amusement apparatus comprising printed material and a sensor pen or wand designed to be grasped by a user and brought into contact with the printed material to enable the pen or wand to sense a parameter or property of a portion of the printed material in which the pen or wand come into contact, wherein the an actual sensing process is triggered by switch means which are actuated by contact between the printed material and the pen or wand, and wherein the pen or wand contains output means with display or audible output being driven in accordance with rules pre-programmed into a sensor module, wherein a programmed nature of a response to be displayed on a visual display or reflected in an audio output alters in response to a combination of switching of the switch means, value of the parameter or property sensed by the sensor when actuated following actuation of the switch means, and timing of the switching of the switch means and the change from one sensed value of the parameter or property to another.
